(19) United States
(12) Patent Application Publication
(10) Pub. No.: US 2006/0254897 A1
(43) Pub. Date: Nov. 16, 2006

(54) Housing cover arrangement of a portable handheld work apparatus

(76) Inventors: Claus-Peter Hamisch, Esslingen (DE); Tobias Wurster, Esslingen (DE); Helmut Schlessmann, Prum (DE); Ralf Blechschmidt, Kernen (DE)

Correspondence Address: WALTER OTTESEN, PO BOX 4026, GAITHERSBURG, MD, 20885-4026, US

(21) Appl. No.: 11/433,543

(22) Filed: May 15, 2006

(30) Foreign Application Priority Data
May 13, 2005 (DE) 20 2005 007 594.9

(51) Int. Cl. H01H 23/00

(52) U.S. Cl. 200/401

(57) ABSTRACT

A housing cover arrangement of a portable handheld work apparatus includes a releasable cover (1) and at least one spring clamp (2) for attaching the cover (1). The spring clamp (2) is pivotally held at one end (3) so it cannot separate and has an elastic latching spring lug (5) at its opposite-lying end (4). The spring clamp (2) is bent over to an approximately U-shaped section (6) at its pivot end (3). An open end (7) of the U-shaped section (6) is closed by an elastic plastic latch (8) while forming a pivot receptacle (9) for a pivot lug (10). The pivot receptacle (9) is essentially closed.

### CROSS REFERENCE TO RELATED APPLICATION

This application claims priority of German patent application no. 20 2005 007 594.9, filed May 13, 2005, the entire content of which is incorporated herein by reference.

### BACKGROUND OF THE INVENTION

Portable handheld work apparatus such as motor-driven chain saws, brushcutters, cutoff machines or the like are utilized under ambient conditions with high dust load and dirt load. A drive motor of the work apparatus configured as an internal combustion engine draws in combustion air via an intake channel and this combustion air is drawn through an air filter for separating the dust entrained in the air flow. Such an air filter is held in an air filter case which is closed by means of a releasable cover. From time to time, the dust load of the air filter requires that the air filter be cleaned or exchanged and, for this purpose, the cover of the air filter case has to be opened. The same applies for the check and exchange of a spark plug which, together with the cylinder head, can be likewise covered. A simple opening and closing of the corresponding cover is wanted for uncomplicated maintenance work.

Portable handheld work apparatus are known wherein a corresponding cover is attached by means of at least one spring clamp. The spring clamp is held pivotally at one of its ends so as not to become separated and, on its opposite-lying end, an elastic latching spring lug is present. The spring lug can manually be latched in or latched out which makes possible a simple opening and closing of the cover.

German patent publication 3,514,242 discloses a spring clamp of the above kind which is configured as a punched and bent component. At the support end, a bearing bushing is formed by bending and this bearing bushing engages about a bearing shaft. The assembly of the bearing bushing onto the bearing shaft is complex and is hardly suited for an automated manufacturing process.

### SUMMARY OF THE INVENTION

It is an object of the invention to provide a housing cover arrangement of a portable handheld work apparatus which makes possible a simple opening and closing of the cover while at the same time providing reduced assembly complexity and manufacturing complexity.

The housing cover arrangement of the invention is for a portable handheld work apparatus. The housing cover arrangement includes: a releasable cover; a spring clamp for attaching the cover; the spring clamp having a first end portion for pivotally connecting the spring clamp to a pivot lug so as to prevent the spring clamp from becoming separable therefrom; the spring clamp having a second end portion opposite the first end portion; the second end portion having an elastic snap-in resilient lug; the spring clamp being bent over to form an approximately U-shaped section at the first end portion with the U-shaped section defining an open end; and, an elastic plastic latch for closing off the open end while forming an essentially closed receptacle for the pivot lug.

A housing cover arrangement is suggested wherein the spring clamp is bent over to form an approximately U-shaped section at the pivot end of the spring clamp. An open end of the U-shaped section is closed by an elastic plastic latch while forming an essentially closed shaft receptacle for a pivot lug. The yielding of the plastic latch permits a simple latching of the spring clamp onto the pivot lug which can easily take place in an automated manner. At the same time, it has been shown that the holding force of the plastic latch is adequate to hold the spring clamp reliably on the pivot lug so that it cannot separate therefrom. The corresponding number of spring clamps can be easily opened by the operator which makes possible an easy removal and opening of the cover. The spring clamps are pivoted about the assigned pivot lug without the disadvantage that they can separate therefrom.

In an advantageous embodiment of the invention, the open end of the U-shaped section has a clear width which corresponds at least approximately to the cross-sectional dimension of the pivot lug. This permits a latching of the pivot lug into the U-shaped section without the latter having to be elastically and resiliently opened wider. Only a suitable deformation of the elastic latch is necessary with slight assembly forces.

In a practical embodiment, a free end of the U-shaped section and the plastic latch are arranged funnel-like to each other referred to a thread-on direction of the pivot lug. In the assembly process, this permits a simple thread-on of the pivot lug into the pivot lug receptacle.

A free end of the plastic latch advantageously projects inclined into the pivot lug receptacle referred to the thread-in direction. The inclined arrangement functions as a detent-like latching mechanism which prevents separation. In the thread-in direction, the pivot lug can be pressed in with a slight application of force and the elastomeric latch yields. In the opposite direction, that is, when pulling off the spring clamp from the pivot lug, the inclined-mounted plastic latch spreads and generates an increased resistance. An unintentional or unwanted separation is prevented. Only by applying a clearly higher force does the plastic give way opposite to its inclined position and clears the connection between spring clamp and pivot lug.

In a practical embodiment, the free end of the plastic latch is grabbed from behind with slight overlapping opposite to the thread-on direction from the free end of the U-shaped section. The overlapping is so matched to the elastic material characteristics of the plastic latch that, with an unintended pull-off of the spring clamp, the free end of the latch lies against the free end of the U-shaped section and is supported by the latter whereby the holding force is increased. With a further increase of the release force, the latch can slide past the free end of the U-shaped section because of its deformability and the pivot lug is cleared whereby a manually releasable connection is provided for maintenance and repair.

The pivot lug is advantageously part of a separate pivot bracket which is made especially of metal and is injected or inserted into a housing part of the work apparatus. The pivot bracket with the pivot lug can be manufactured from a suitable high-strength material which prevents a break out of the spring clamp from its support location. At the same time, the occurring pivot forces are introduced into the housing part preferably made of thin plastic because of the insertion or selectively also the injection of the pivot bracket into the housing part at low manufacturing cost. The arrangement can be configured to have a thin wall and light weight while maintaining the required strength.

In a practical embodiment, the spring clamp has a metal spring bracket especially made from spring sheet steel and this spring bracket is at least partially enclosed by an elastic plastic jacket. The plastic latch is configured as one part with the plastic jacket. In addition to an optical improvement of the appearance of the spring clamp, the plastic jacket contributes to an improved graspability and therefore an easier manipulability. The plastic jacket satisfies also a purpose as protection against dirt and corrosion. The one part configuration with the plastic latch permits a simple manufacture by coating and the number of manufacturing steps is minimized while maintaining easy assembly.

The spring lug of the spring bracket lies on its end facing toward a latch edge at least partially free. The metallic surface of the spring lug slides on the latch edge when snapping in and snapping out. Slight actuating forces with low wear are obtained with a friction pair having a latch edge formed of plastic.

In an advantageous embodiment, the spring lug of the spring bracket is formed by a further U-shaped bent section. This bent section has an open region which is directed outwardly from a cover surface and is so filled by the plastic jacket that an outer surface is aligned with a center part of the spring bracket at least approximately. The U-shaped configuration of the spring lug advantageously provides latch characteristics and clamping characteristics. The formation of an aligned surface, which covers the open region of the U-shape, prevents a settling of dirt on the spring clamp. The preferably rubber elastic material characteristics of the plastic jacket do not affect the desired spring characteristics of the spring bracket.

The elastic plastic jacket has a non-slip structuring on its outer surface. Advantageously, a grip projection, which is formed by the plastic jacket, can be provided in the region of the spring lug for releasing the spring clamp. The manipulability of the spring clamp is improved for difficult, such as cold, ambient conditions where the operator has limited moveability of the fingers.

### BRIEF DESCRIPTION OF THE DRAWINGS

The invention will now be described with reference to the drawings wherein:

FIG. 1 is a side elevation view of a portable handheld work apparatus which here is a chain saw having an air filter case cover and a spring clamp for attachment;

FIG. 2 is a perspective exploded view showing the individual components of the air filter case arrangement of FIG. 1;

FIG. 3 is an inner view of the air filter case of FIGS. 1 and 2 showing details for the attachment of the spring clamps;

FIG. 4 is an enlarged view of the pivot bracket for pivotally supporting the spring clamp;

FIG. 5 shows the detail V of FIG. 3 with details of the support of the spring clamp on the pivot bracket of FIG. 4;

FIG. 6 is a longitudinal section view of an embodiment of the spring clamp;

FIG. 7 is a perspective plan view of the spring clamp of FIG. 5 with a plastic jacket structured on the outside; and,

FIG. 8 is a perspective view from below of the spring clamp of FIGS. 5 and 6 with a partially exposed spring lug.

### DESCRIPTION OF THE PREFERRED EMBODIMENTS OF THE INVENTION

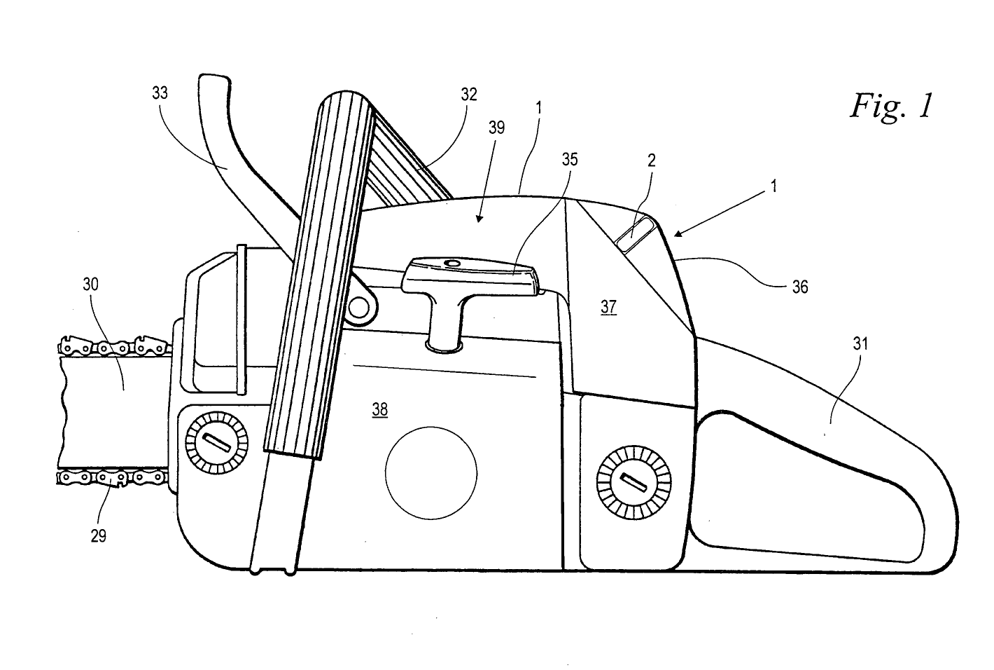

FIG. 1 shows a portable handheld work apparatus which is here a chain saw by way of example. The work apparatus could also be a brushcutter, cutoff machine or the like. The chain saw is provided with a motor housing 38 on which a guide bar 30 is attached. A saw chain 29 runs along the periphery of the guide bar. A drive motor in the form of an internal combustion engine 39 is mounted in the motor housing 38 and the engine drives the saw chain 29. A pull-rope starter 35 is provided for starting the engine 39. A rearward handle 31 and a forward handle 32 are attached to the motor housing 38 for guiding the chain saw. A brake lever 33 is provided forward of the forward handle 32 and functions to release a braking device for bringing the saw chain 29 to standstill.

During operation, the engine 39 draws in combustion air through an intake channel. In a carburetor (not shown), fuel is metered to the combustion air flow and an ignitable air/fuel mixture is formed. Upstream of the carburetor, an air filter is provided for cleaning the combustion air flow. The exchangeable filter is held in an air filter case 37. The cylinder head of the engine 39 with the threadably engaged spark plug and the air filter case 37 are covered with their own respective covers 1 during operation. The rearward cover 1 forms an air filter case cover 36 attached to the air filter case 37 so as to be releasable. The case 37 and the cover 36 conjointly protectively surround the air filter held therein without interfering with the supply of combustion air. In addition to the purely covering function, the air filter case cover 36 can also provide a function for fixing the air filter in the air filter case 37.

In its closed position, the air filter case cover 36 is fixed relative to the air filter case 37 by at least one spring clamp 2 indicated here and described in greater detail hereinafter. After releasing one or several spring clamps 2, the air filter case cover 36 can be removed whereby access to the air filter is provided. In lieu of a simple removability, a pivot support of the air filter case cover 36 can be practical. The forward cover 1 can be attached in the same manner on the engine housing 38.

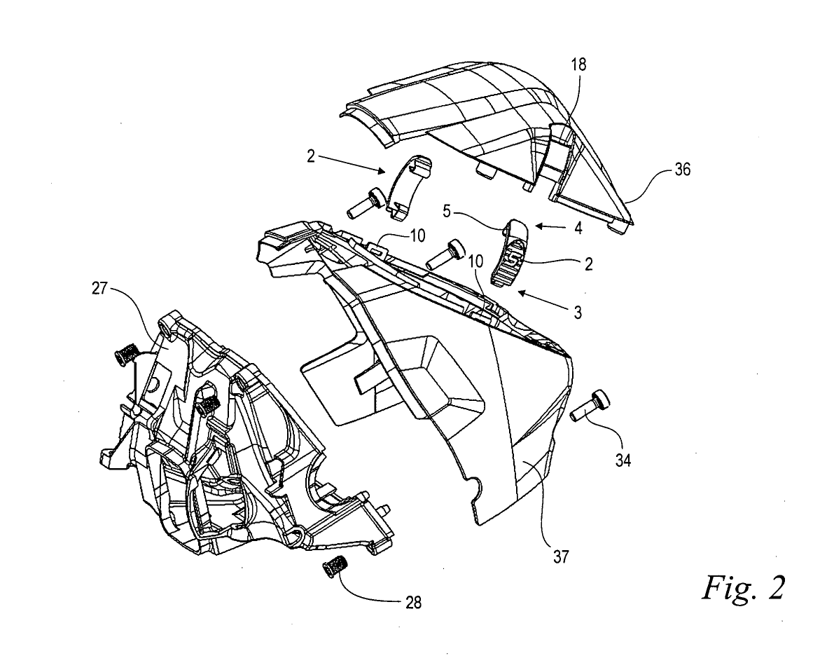

FIG. 2 shows the individual components of the region of the air filter case 37 of FIG. 1 in a perspective exploded view. A carburetor case 27 is provided for accommodating a carburetor (not shown) for the internal combustion engine 39 (FIG. 1). The carburetor case 27 is provided with a plurality of threaded bushings 28. The air filter case 37 is threadably fastened to the carburetor case 27 by means of screws 34 in that the screws 34 are rotated into the threaded bushings 28. A total of two spring clamps 2 are provided for attaching the air filter case cover 36 which covers the open end of the air filter case 37. After releasing the two spring clamps 2, the air filter case cover 36 can be completely lifted off. It can also be practical to attach the air filter case cover 36 and/or additional covers 1 pivotally to the work apparatus. In such a case, the corresponding cover 1 is flipped open after releasing the spring clamps 2.

The spring clamp 2 is pivotally held at its one end 3 to pivot lug 10 of the air filter case 37 so as not to be separable therefrom as will be shown in greater detail hereinafter. The spring clamp 2 has an elastic latchable resilient lug 5 at its opposite-lying end 4. For this purpose, the air filter case cover 36 is provided with respective latch edges 18 at suitable locations which, in the closed state, are grasped from behind by the resilient lugs 5 of the respective spring clamps 2.

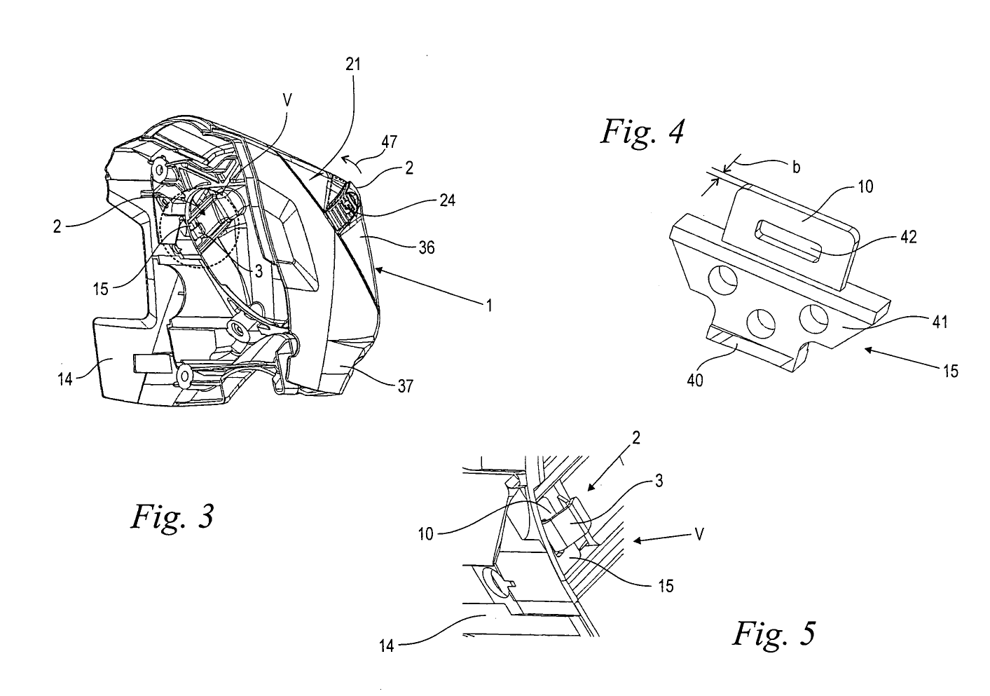

FIG. 3 shows the air filter case 37 of FIGS. 1 and 2 in a perspective inner view. The air filter case 37 forms a housing part 14 on which the two spring clamps 2 are pivotally attached. It can also be practical to support the at least one spring clamp 2 pivotally on the cover 1. The assigned latch edge 18 (FIG. 2) is then to be assigned to the adjoining housing part 14.

A pivot bracket 15 is provided for the pivot support of the pivot end 3 of the spring clamp 2. The pivot bracket 15 is injected into the pivot end housing part 14 which is manufactured of injection molded plastic. The pivot bracket 15 can also be inserted into the housing part 14. Additional details as to the pivot support by means of the pivot bracket 15 are described in greater detail with respect to FIGS. 4 and 5 hereinafter.

FIG. 3 also shows that the spring clamp 2 is in the half open position. In the closed state (shown in phantom outline) after pivoting in a closing direction 47, an outer surface 24 at least approximately follows the contour of a cover surface 21 of cover 1 or of the air filter case cover 36. The outer surface 24 of the spring clamp 2 is only slightly curved and is in alignment at least approximately with the cover surface 21 which is likewise only slightly curved.

FIG. 4 shows an enlarged view of the pivot bracket 15 of FIG. 3. In the embodiment shown, the pivot bracket 15 is made of metal but can, however, also be advantageously manufactured of fracture-resistant plastic or the like. A stop 40 extends from the center part 41 configured essentially flat. The stop 40 projects in both directions beyond the flat sides of the center part 41. The center part 41 is provided with circular holes 48. A closed cutout 42 is provided opposite the stop 40 via which the pivot lug 10 is formed. The pivot lug 10 is connected at both ends tightly to the center part 41. In the embodiment shown, the pivot lug 10 has a rectangular cross section with a cross section dimension (b). The cross section can also be round.

In FIG. 5, the detail V of FIG. 3 is shown enlarged. According to FIG. 5, the pivot lug 15 is injected into the housing part 14 and is shown in greater detail in FIG. 4. The injection molded plastic of the housing part 14 form tightly surrounds the center part 41 (FIG. 4) having a stop 40 and passes through the holes 48. For attachment in the form of an insert connection, the pivot bracket can be inserted or pushed so far into a suitable receptacle of the housing part 14 that the stop 40 comes into contact engagement against a corresponding support of the housing part 14. The receptacle for the pivot bracket 15 is so configured that its region with the pivot lug 10 is exposed. The pivot end 3 of the spring clamp 2 is pivotally supported at the pivot lug 10.

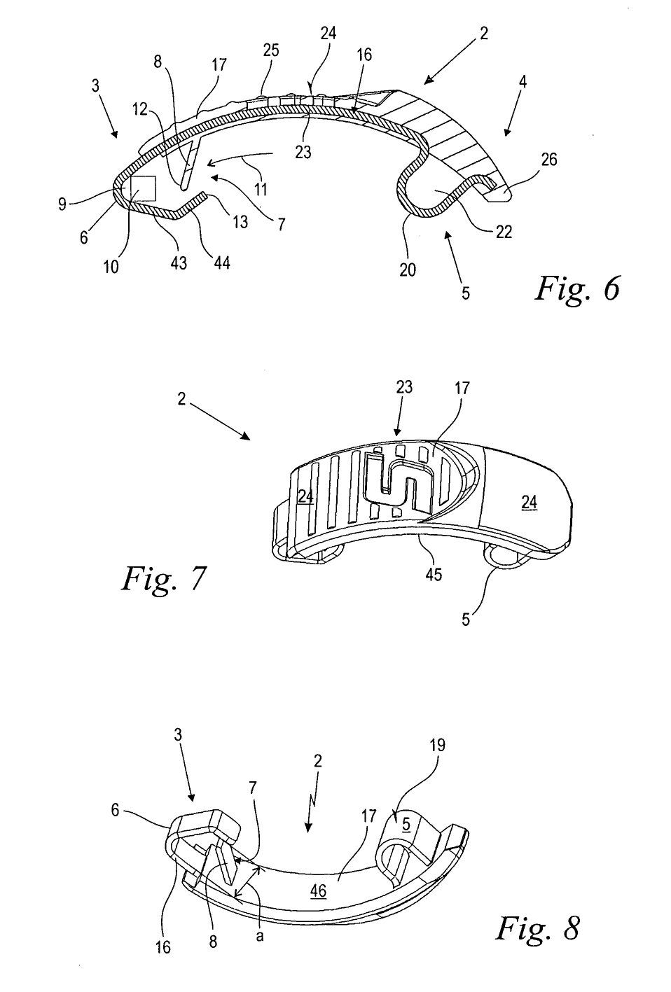

FIG. 6 shows a longitudinal section view of an embodiment of the spring clamp 2 of the invention. The spring clamp 2 has mechanical, elastic resilient characteristics which are determined essentially by a spring bracket 16 (FIG. 8) bent from spring steel sheet metal. An essentially straight line middle part 23 follows the contour of the air filter case cover 36 (FIG. 3) in a slight curve. From the middle part 23, an inwardly bent section 43 extends which, via a further bend, passes into an end section 44 which runs back parallel to the center part 23.

An open end 7 of the U-shaped section 6 is virtually completely closed by means of an elastic plastic latch 8. A gap remains between a free end 12 of the plastic latch 8 and a free end 13 of the end section 44.

An almost closed pivot receptacle 9 for the pivot lug 10 is formed by the U-shaped section 6 and the plastic latch 8. The latch 8 closes the open end 7 so far that the spring clamp 2 is held on the pivot lug 10 so that it cannot separate therefrom. The pivot lug 10 has an approximately square cross section and is held with play so as to be rotatable or pivotable in the pivot receptacle 9. Also, deviating cross sections of the pivot lug 10 can be selected which deviate, for example, with a round cross section form.

The plastic latch 8 is made of a suitable plastic material or an elastomer such as a rubber-elastic plastic material or natural rubber material and in the embodiment shown, is formed as a flat lip which is elastically yielding in a thread-in direction 11. The free end 13 of the end section 44 and therefore of the U-shaped section 6 and the plastic latch 8 are, referred to the thread-in direction 11 of the pivot lug 10, arranged funnel-like to each other. For assembling the spring clamp 2 at the pivot lug 10, the pivot lug 10 can be pressed against the elastic plastic latch 8 in the thread-in direction 11. The plastic latch 8 yields elastically in the interior of the pivot receptacle 9. After the pivot lug 10 snaps into the assembly position shown, the plastic latch springs back into the rest position and latch position shown.

The free end 12 of the latch 8 projects inclined into the pivot receptacle 9 referred to the thread-in direction 11 and is clasped from behind opposite to the thread-in direction 11 by the free end 13 of the U-shaped section 6 with slight overlapping. For an attempted pullout of the pivot lug 10 from the pivot receptacle 9, the pivot lug 10 spreads the latch at first in a barb-like manner opposite to the thread-in direction 11. The free end 12 of the latch 8 lies with slight overlapping against the free end 13 of the end section 44. Only after developing an additional manual force, the elastic latch 8 deforms so far that its free end 12 slides past the free end 13 of the end section 44 and clears the pivot lug 10 in the direction opposite to the thread-in direction 11.

The spring bracket 16 is bent over at its end 4 to form a further U-shaped section 20 in such a manner that the spring lug 5 is formed. The end 4 lies opposite to the pivot end 3. The spring bracket 16 is coated for the most part with an elastic plastic jacket 17. A region 22 is open directed outwardly from the cover surface 21 (FIG. 3) or specifically, from the outer surface 24 of the spring clamp 2. The plastic jacket 17 extends over the region 22 in such a manner that an outer surface 24 is formed which is slightly curved and aligned with the center part 23 of the spring bracket 16 at least approximately. The plastic jacket 17 projects outwardly in the longitudinal direction while forming a grip projection 26 in the region of the opposite-lying end 4. To open the spring clamp 2, an operator can grasp with the fingers of a hand below the grip projection 26 and the spring lug or projection 5 is pulled off of the latch edge 18 (FIG. 2). On the outer surface 24, the plastic jacket 17 is further provided with a structuring 25. The plastic jacket 17 is injected onto the spring bracket 16 and therearound and encloses also its lower side. The latch 8 is configured as a single piece and is of unitary material with the plastic jacket 17.

The perspective plan view of the spring clamp 2 in FIG. 7 shows that the plastic jacket 17, in addition to the outer surface 24, also forms side surfaces 45 in the region of the center part 23.

In FIG. 8, a perspective bottom view of the spring clamp 2 of FIGS. 6 and 7 is shown. In FIG. 8, the plastic jacket 17 also covers an inner surface 46 of the spring bracket 16. Only the region of the pivot end 3 (of which only the lower side is shown) as well as the region of the spring lug 5 on its end 19 facing toward the latch edge 18 (FIG. 2) are not covered by the plastic jacket 17. These regions are exposed as blank metal. The metallic blank surface 19 of the spring lug 5 glides on the latch edge 18 (FIG. 2) when actuated and they conjointly form a friction pair of metal/plastic.

The U-shaped section 6 has a clear width (a) up to its open end 7 which corresponds at least approximately to the cross-sectional dimension (b) of the pivot lug 10 (FIG. 4). This permits a threading in of the pivot lug 10 through the open end 7 into the U-shaped section 6. In the clear distance (a), the thickness of the threaded-in plastic latch 8 is also considered on which the pivot lug 10 (FIG. 6) slides past when threading in without it being necessary to widen the U-shaped section 6.

It is understood that the foregoing description is that of the preferred embodiments of the invention and that various changes and modifications may be made thereto without departing from the spirit and scope of the invention as defined in the appended claims.

What is claimed is:

1. A housing cover arrangement of a portable handheld work apparatus, the housing cover arrangement comprising:
a releasable cover;
a spring clamp for attaching the cover;
said spring clamp having a first end portion for pivotally connecting said spring clamp to a pivot lug so as to prevent said spring clamp from becoming separable therefrom;
said spring clamp having a second end portion opposite said first end portion;
said second end portion having an elastic snap-in resilient lug;
said spring clamp being bent over to form an approximately U-shaped section at said first end portion with said U-shaped section defining an open end; and,
an elastic plastic latch for closing off said open end while forming an essentially closed receptacle for said pivot lug.

2. The housing cover arrangement of claim 1, wherein said open end of said U-shaped section has a clear width (a) which corresponds at least approximately to the cross-sectional dimension (b) of said pivot lug.

3. The housing cover arrangement of claim 1, wherein said pivot lug is moved in a thread-in direction when connecting said spring clamp to said pivot lug; said U-shaped section has a free end; and, said free end and said plastic latch are arranged in a funnel shape to each other referred to said thread-in direction.

4. The housing cover arrangement of claim 3, wherein said plastic latch projects into said receptacle inclined referred to said thread-in direction.

5. The housing cover arrangement of claim 4, said plastic latch having a free end; and, said U-shaped section having a free end extending behind said free end of said plastic latch with a slight overlapment.

6. The housing cover arrangement of claim 1, further comprising a housing part of said work apparatus coacting with said releasable cover; a separate pivot bracket; and, said pivot lug being part of said pivot bracket.

7. The housing cover arrangement of claim 6, wherein said pivot bracket is inserted or injected into said housing part.

8. The housing cover arrangement of claim 7, wherein said pivot lug is made of metal.

9. The housing cover arrangement of claim 1, wherein said spring clamp includes: a metal spring bracket; an elastic plastic jacket at least partially enclosing said spring bracket; and, said plastic latch is formed as an integral part of said plastic jacket.

10. The housing cover arrangement of claim 9, wherein said metal spring bracket is made of resilient steel sheet metal.

11. The housing cover arrangement of claim 9, wherein said spring bracket is coated with plastic to form said plastic jacket.

12. The housing cover arrangement of claim 9, wherein said cover has a latch edge; said spring bracket has a spring lug having a side facing toward said latch edge; and, said side is at least partially exposed.

13. The housing cover arrangement of claim 9, wherein said U-shaped section is a first U-shaped section; said second end portion is formed as a second U-shaped section of said spring clamp to define said resilient lug; said second U-shaped section has an open region facing outwardly from the surface of said cover; and, said region is bridged by said plastic jacket in such a manner that an outer surface is formed which at least approximately aligns with a center portion of said spring bracket.

14. The housing cover arrangement of claim 9, wherein said plastic jacket has an outer surface structured to facilitate gripping the same.

15. The housing cover arrangement of claim 9, wherein said plastic jacket is formed to define a grip projection projecting outwardly in the region of said resilient lug to facilitate the release of said spring clamp.

16. The housing cover arrangement of claim 1, wherein said plastic latch is made of an elastomer.

17. The housing cover arrangement of claim 1, wherein said work apparatus is a motor-driven chain saw, cutoff machine or brushcutter.
